(19) United States
(12) Patent Application Publication
(10) Pub. No.: US 2013/0284209 A1
(43) Pub. Date: Oct. 31, 2013

(54) APPARATUS AND METHOD FOR CLEANING SUBSTRATES

(71) Applicant: SEMES CO., LTD., CHUNGCHEONGNAM-DO (KR)

(72) Inventors: YU HWAN KIM, INCHEON (KR); BYUNG MAN KANG, CHUNGCHEONGNAM-DO (KR); SE HOON OH, CHUNGCHEONGNAM-DO (KR); YEON JOON KIM, CHUNGCHEONGNAM-DO (KR)

(73) Assignee: SEMES CO., LTD., CHUNGCHEONGNAM-DO (KR)

(21) Appl. No.: 13/873,516

(22) Filed: Apr. 30, 2013

(30) Foreign Application Priority Data
Apr. 30, 2012 (KR) 10-2012-0045851
Oct. 4, 2012 (KR) 10-2012-0110149

(51) Int. Cl. B08B 3/10

(52) U.S. Cl. CPC B08B 3/10
USPC 134/19; 134/61

(57) ABSTRACT

The substrate cleaning apparatus includes a first process chamber in which a liquid treating process is performed on a substrate by supplying a treating solution, a second process chamber in which a drying process is performed on the substrate, and a carrying unit carrying the substrate between the first process chamber and the second process chamber. The first process chamber includes a liquid treating housing providing a space in which the liquid treating process is performed on the substrate, a spin chuck supporting the substrate within the liquid treating housing, and a liquid supply member supplying the treating solution onto the substrate supported by the spin chuck. The second process chamber includes a drying housing providing a space in which the substrate is dried, a substrate support member supporting the substrate within the drying housing, and a heater heating the substrate.

### CROSS-REFERENCE TO RELATED APPLICATIONS

This U.S. non-provisional patent application claims priority under 35 U.S.C. §119 of Korean Patent Application Nos. 10-2012-0045851, filed on 30 Apr. 2012, and 10-2012-0110149, filed on 4 Oct. 2012, the entire contents of which are hereby incorporated by reference.

### BACKGROUND OF THE INVENTION

The present invention disclosed herein relates to an apparatus and method for manufacturing a semiconductor substrate, and more particularly, to an apparatus and method for cleaning a substrate.

In general, semiconductor devices are manufactured by performing various processes such as a photo process, an etching process, an ion implantation process, and a deposition process on substrates such as wafers.

Also, a cleaning process for removing various contaminants attached to the substrates is performed while each of the processes is performed. The cleaning process includes a chemical treating process for removing the contaminants attached to the substrates by using chemicals, a wet cleaning process for removing the chemicals remaining on the substrates by using pure water, and a drying process for removing the pure water remaining on surfaces of the substrates by supplying a dry fluid.

Among these, the drying process is performed by supplying a nitrogen gas onto the substrate on which the pure water remains. However, as a line width of each of patterns formed on a substrate decreases, and an aspect ratio of each of the patterns increases, it may difficult to remove the pure water existing among the patterns. In recent, a liquid organic solvent such as isopropyl alcohol having volatility greater than and surface tension less than that of the pure water may be substituted for the pure water, and then, the nitrogen gas may be supplied to dry the substrate.

In spite of this method, a pattern surface of the substrate may not be uniformly dried to cause pattern collapse. Hereinafter, an occurrence process of a leaning phenomenon occurring during the drying process will be described.

FIGS. 1 and 2 are views illustrating a process in which a leaning phenomenon of a substrate occurs while the substrate is dried by using a purge gas.

Referring to FIG. 1, when an organic solvent or pure water remains on patterns P of a substrate W, a purge gas may be supplied onto an upper portion of the substrate W to dry the substrate W. For example, a purge gas supply member 460 is disposed above the substrate W to supply the purge gas onto an entire area of the substrate W while moving between a central region and an edge region of the substrate W. Although not shown, the substrate W may rotate while the purge gas is supplied. Even though the above-described drying process is performed, drying rates among the patterns P formed on the substrate W may be different.

Referring to FIG. 2, when the drying rates among the patterns P of the substrate W are different, an amount of treating solution or pure water remaining among the patterns P may be different. Thus, surface tension generated on the remaining solution among the patterns P of the substrate W may be different. When the surface tension difference among the patterns P occurs, force applied in left and right directions of each of the patterns P may be different to cause a leaning phenomenon of the pattern P.

The substrate treating process may be reduced in efficiency due to the leaning phenomenon.

### SUMMARY OF THE INVENTION

The present invention provides an apparatus and method for cleaning a substrate, which are capable of improving drying efficiency on the substrate.

The present invention also provides an apparatus and method for cleaning a substrate, which dry an entire area of the substrate at a substantially uniform rate to prevent a leaning phenomenon of a pattern on the substrate from occurring.

The feature of the present invention is not limited to the aforesaid, but other features not described herein will be clearly understood by those skilled in the art from descriptions below.

Embodiments of the present invention provide substrate cleaning apparatuses. The substrate cleaning apparatus include: a first process chamber in which a liquid treating process is performed on a substrate by supplying a treating solution; a second process chamber in which a drying process is performed on the substrate; and a carrying unit carrying the substrate between the first process chamber and the second process chamber, wherein the first process chamber includes: a liquid treating housing providing a space in which the liquid treating process is performed on the substrate; a spin chuck supporting the substrate within the liquid treating housing; and a liquid supply member supplying the treating solution onto the substrate supported by the spin chuck, wherein the second process chamber includes: a drying housing providing a space in which the substrate is dried; a substrate support member supporting the substrate within the drying housing; and a heater heating the substrate.

In some embodiments, the substrate support member may have a top surface that is formed of a material having heat resistance greater than that of a top surface of the spin chuck.

In other embodiments, the top surface of the substrate support member may be formed of a steel material, and the top surface of the spin chuck may be formed of a Teflon material.

In still other embodiments, the heater may be disposed in the substrate support member.

In even other embodiments, the second process chamber may further include: a purge gas supply member supplying a purge gas into the drying housing; and an exhaust member the purge gas and fume to the outside of the drying housing.

In yet other embodiments, the purge gas may include an inert gas.

In further embodiments, the substrate support member may include: a support plate disposed on the substrate support member to face the substrate, the support plate being rotated together with the substrate; and a rotation member rotating the support plate.

In other embodiments of the present invention, substrate cleaning apparatuses include: a first process chamber in which a liquid treating process is performed on a substrate by supplying a treating solution; a carrying unit carrying the substrate from the first process chamber; and a drying member drying the carried substrate, wherein the drying member is disposed in the carrying unit.

In some embodiments, the carrying unit may include: a base; a housing disposed on the base to provide a space in which the substrate is dried; and a robot arm supporting the substrate, the robot arm being movable between a first position at which the substrate moves into a cleaning chamber and a second position at which the substrate within the housing is dried.

In other embodiments, the drying member may be disposed within the housing.

In still other embodiments, the drying member may be disposed above a moving path of the robot arm within the housing.

In even other embodiments, the housing may further include: a purge gas supply member supplying a purge gas into the housing; and an exhaust member the purge gas and fume to the outside of the housing.

In still other embodiments of the present invention, substrate cleaning methods are provided. The substrate cleaning methods include: performing a liquid treating process on a substrate; and drying the substrate, wherein, in the drying of the substrate, the substrate is dried by heating.

In some embodiments, the liquid treating process may be performed in a first process chamber, and the drying process may be performed in a second process chamber.

In other embodiments, the drying process may be performed after the liquid treating process is performed without supplying another treating solution.

In still other embodiments, the liquid treating process may include: supplying pure water onto the substrate; and supplying a liquid organic solvent onto the substrate.

In even other embodiments, the methods may further include introducing a purge gas into the second process chamber to exhaust the purge gas together a gas introduced into the outside of the second process chamber, evaporated pure water, or an organic solvent to the outside of the second process chamber.

In yet other embodiments, the purge gas may include an inert gas.

In further embodiments, the exhaust process may start at a time point at which the substrate is carried into the second process chamber.

In still further embodiments, the methods may further include carrying the substrate between the chambers, wherein the liquid treating process is performed in a first process chamber, and the drying process may be performed in a carrying unit by which the substrate is carried from the first process chamber after the liquid treating process is performed.

In yet further embodiments, the drying process may be performed in a first process chamber in which the liquid treating process is performed on the substrate.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1 and 2 are views illustrating a process in which a leaning phenomenon of a substrate occurs while the substrate is dried by using a purge gas;

FIG. 3 is a plan view of a substrate treating apparatus according to an embodiment of the present invention;

FIG. 4 is a cross-sectional view illustrating a first substrate cleaning apparatus of FIG. 3 according to an embodiment of the present invention;

FIG. 5 is a cross-sectional view illustrating a second substrate cleaning apparatus of FIG. 3 according to an embodiment of the present invention;

FIG. 6 is a plan view of a substrate treating apparatus according to another embodiment of the present invention;

FIG. 7 is a cross-sectional view illustrating a substrate cleaning apparatus of FIG. 6 according to another embodiment of the present invention;

FIG. 8 is a plan view of a substrate treating apparatus according to further another embodiment of the present invention;

FIG. 9 is a cross-sectional view illustrating a substrate cleaning apparatus of FIG. 8 according to further another embodiment of the present invention; and

FIG. 10 is a flowchart illustrating a method for cleaning a substrate by using the substrate treating apparatus of FIG. 3.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the drawings, the thicknesses of layers and regions are exaggerated for clarity.

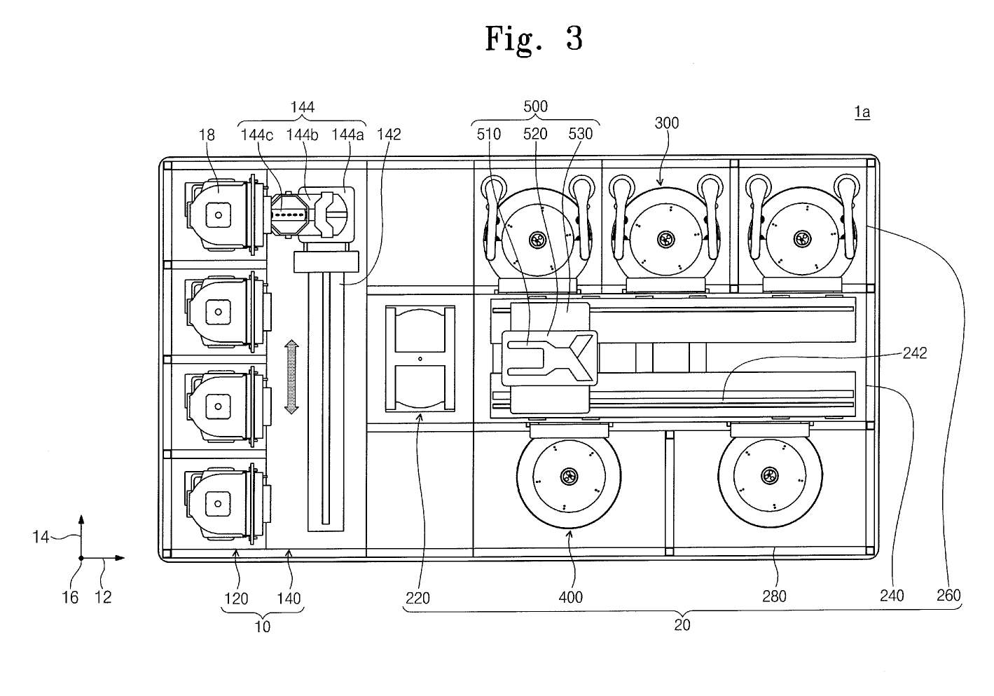

FIG. 3 is a plan view of a substrate treating apparatus according to an embodiment of the present invention.

Referring to FIG. 3, a substrate treating apparatus 1a includes an index module 10 and a process processing module 20. The index module 10 includes a load port 120 and a transfer frame 140. The load port 120, the transfer frame 140, and the process processing module 20 are successively disposed in a line. Hereinafter, a direction in which the load port 120, the transfer frame 140, and the process processing module 20 are arranged is referred to as a first direction 12. Also, when viewed from an upper side, a direction perpendicular to the first direction 12 is referred to as a second direction 14, and a direction perpendicular to a plane parallel to the first and second directions 12 and 14 is referred to as a third direction 16.

A carrier 18 in which a substrate is accommodated is seated on the load port 140. The load port 120 is provided in plurality. The plurality of load ports 10 are arranged in a line along the second direction 14. The number of load ports 120 may increase or decrease according to process efficiency and foot print conditions of the substrate processing module 20. A plurality of slots for accommodating substrates in a state where the substrates are disposed parallel to the ground are defined in the carrier 18. A front opening unified pod (FOUP) may be used as the carrier 18.

The process processing module 20 includes a transfer chamber 240, a buffer unit 220, a first process chamber 260, and a second process chamber 280. The transfer chamber 240 has a length direction parallel to the first direction 12. The first process chamber 260 and the second process chamber 280 are disposed on both sides of the transfer chamber 240. The first and second process chambers 260 and 240 may be disposed symmetrical to each other with respect to the transfer chamber 240 on the one side and the other side of the transfer chamber 240. A plurality of first process chambers 260 are disposed on the one side of the transfer chamber 240. Portions of the first process chambers 260 are disposed along a length direction of the transfer chamber 240. Also, portions of the first process chambers 260 are stacked on each other. That is, the first process chambers 260 may be disposed in an A×B array on the one side of the transfer chamber 240. Here, the reference symbol “A” represents the number of process chambers 260 disposed in a line along the first direction 12, and the reference symbol “B” represents the number of process chambers 260 disposed in a line along the third direction 16. When four or six first process chambers 260 are disposed on the one side of the transfer chamber 240, the first process chambers 260 may be disposed in a 2×2 or 3×2 array. The number of first process chamber 260 may increase or decrease. Also, like the first process chambers 260, the second process chambers 280 may be disposed in an M×N (each of M and N is a natural number greater than or equal to 1). Here, M and N may be the same number as A and B, respectively. Alternatively, all the first and second process chambers 260 and 280 may be disposed on only the one side of the transfer chamber 240. Alternatively, the first and second process chambers 260 and 280 may be disposed on the one side and the other side of the transfer chamber 240 with single-layered structures, respectively. Alternatively, the first and second process chambers 260 and 280 may be stacked on each other on the one side or the other side of the transfer chamber 240. Also, the first and second process chamber 260 and 280 may be disposed in various manners unlike the above-described arrangement.

The buffer unit 220 is disposed between the transfer frame 140 and the transfer chamber 240. The buffer unit 220 provides a space in which substrates stay before the substrates are carried between the process chamber 260 and the carrier 18. The buffer unit 220 includes a slot in which a substrate is placed therein. The slot may be provided in plurality, and the plurality of slots may be spaced apart from each other along the third direction 16. In the buffer unit 220, a surface facing the transfer frame 140 and a surface facing the transfer chamber 240 are opened.

The transfer frame 140 carries substrates between the carrier 18 seated on the load port 120 and the buffer unit 220. An index rail 142 and an index robot 144 are disposed on the transfer frame 140. The index rail 142 has a length direction parallel to the second direction 14. The index robot 144 is disposed on the index rail 142 to linearly move in the second direction 14 along the index rail 142. The index robot 144 includes a base 144a, a main body 144b, and an index arm 144c. The base 144a is disposed movable along the index rail 142. The main body 144b is coupled to the base 144a. The main body 144b is disposed movable along the third direction 16 on the base 144a. Also, the main body 144b is rotatably disposed on the base 144a. The index arm 144c is coupled to the main body 144b. Also, the index arm 144c may move in forward and backward directions with respect to the main body 144b. The index arm 144c may be provided in plurality. The plurality of index arms 144c may be individually operated. The index arms 144c may be stacked on each other in a state where the index arms 144c are spaced apart from each other along the third direction 16. Portions of the index arms 144c may be used for carrying substrates into the carrier 18 from the process processing module 20, and other portions of the index arms 144c may be used for transferring substrates into the process processing module 20 from the carrier 18. Thus, it may prevent particles generated from the substrates to be processed while the index robot 144 loads and unloads substrates from being attached to the processed substrates.

The transfer chamber 240 carries substrates between the buffer unit 240 and the process chamber 260 and between the process chambers 260. A guide rail 242 and a carrying unit 500 are disposed in the transfer chamber 240. The guide rail 242 has a length direction parallel to the first direction 12. The carrying unit 500 is disposed on the guide rail 242 to linearly move in the first direction 12 along the guide rail 242. The transfer unit 500 includes a base 530, a main body 520, and a main arm 510. The base 530 is disposed movable along the guide rail 242. The main body 520 is coupled to the base 530. The main body 520 is disposed movable along the third direction 16 on the base 530.

Also, the main body 520 is rotatably disposed on the base 530. The main arm 510 is coupled to the main body 520. Also, the main arm 510 may move in forward and backward directions with respect to the main body 520. The main arm 510 may be provided in plurality. The plurality of main arms 510 may be individually operated. The main arms 510 may be staked on each other in a state where the main arms 510 are spaced apart from each other along the third direction 16.

Substrate cleaning apparatuses 300 and 400 for performing a cleaning process on substrates are disposed within the process chambers 260 and 280. The substrate cleaning apparatuses 300 and 400 may have different structures according to a kind of cleaning processes to be performed. Alternatively, the substrate cleaning apparatuses within each of the process chambers may have the same structure. Alternatively, the process chambers 260 and 280 may be classified into a plurality of groups. The substrate cleaning apparatuses 300 within the process chambers 260 belonging to the same group may be the same structure. On the other hand, the substrate cleaning apparatuses 400 within the process chambers 260 belonging to the groups different from each other may have structures different from each other. For example, when the process chambers 260 and 280 are divided into two groups, the process chambers 260 of a first group may be disposed on one side of the transfer chamber 240, and the process chambers 280 of a second group may be disposed on the other side of the transfer chamber 240. Alternatively, the process chambers 260 of the first group may be disposed on a lower floor, and the process chambers 280 of the second group may be disposed on an upper floor on both sides of the transfer chamber 240. The process chambers of the first group and the process chambers 280 of the second group may be distinguished from each other according to a kind of chemicals and a kind of cleaning methods. On the other hand, the process chambers 260 of the first group and the process chambers 280 of the second group may be provided to successively perform processes on one substrate W.

Hereinafter, a substrate cleaning apparatus for cleaning a substrate by using a treating solution according to an embodiment will be described.

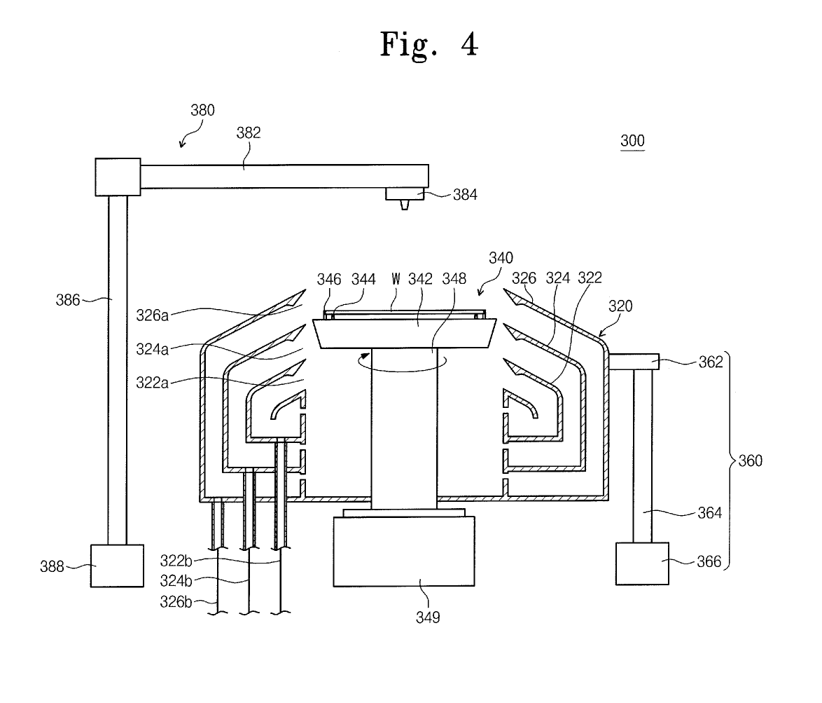

FIG. 4 is a cross-sectional view illustrating a first substrate cleaning apparatus of FIG. 3 according to an embodiment of the present invention.

Referring to FIG. 4, a first substrate cleaning apparatus 300 includes a container 320, a spin chuck 340, an elevation unit 360, and a liquid supply member 380. The first substrate cleaning apparatus 300 is disposed within a liquid treating housing (not shown) of a first process chamber 260.

The container 320 provides a space in which a substrate cleaning process is performed and has an opened upper portion. The container 320 includes an internal recovery box 322, an intermediate recovery box 324, and an external recovery box 326. Each of recovery boxes 322, 324, and 326 recovers the different treating solutions of the treating solutions used for the processes. The internal recovery box 322 has a circular ring shape surrounding the spin chuck 340, the intermediate recovery box 324 has a circular ring shape surrounding the internal recovery box 322, and the external recovery box 326 has a circular ring shape surrounding the intermediate recovery box 324. An inner space 322a of the internal recovery box 322, a space 324a between the internal recovery box 322 and the intermediate recovery box 324, and a space 326a between the intermediate recovery box 324 and the external recovery box 326 may serve as inlets through which the treating solutions are introduced into the internal recovery box 322, the intermediate recovery box 324, and the external recovery box 326, respectively. Recovery lines 322b, 324b, and 326b vertically extending downward from bottom surfaces of the recovery boxes 322, 324, and 326 are connected to the recovery boxes 322, 324, and 326, respectively. The treating solution introduced into each of the recovery boxes 322, 324, and 326 is discharged through each of the recovery lines 322b, 324b, and 326b. The discharged treating solution may be reused through an external treating solution recycling system (not shown).

The spin chuck 340 is disposed within the container 320. The spin chuck 340 supports and rotates a substrate W while a process is performed. The spin chuck 340 includes a main body 342, a support pin 344, a chucking pin 346, and a support shaft 348. The main body 342 has a top surface having a circular shape when viewed from an upper side. The support shaft 348 rotatable by a motor 349 is fixed and coupled to a bottom surface of the main body 342. The support pin 344 is provided in plurality. The support pins 344 are disposed on an edge of the top surface of the main body 342 and spaced apart from each other to protrude upward from the main body 342. The support pins 344 may be combined with each other to form a circular ring shape on the whole. The support pins 344 supports an edge of a back surface of the substrate W so that the substrate W is spaced a predetermined distance from the top surface of the main body 342. The chucking pin 346 is provided in plurality. The chucking pins are disposed further away from a center of the main body 342 when compared to the support pins 344 away from the center of the main body 342. The chucking pins 346 provide from an upper portion of the main body 342. The chucking pins 346 support side portions of the substrate W to prevent the substrate W from being separated from a proper position thereof in a lateral direction when the spin chucks 340 are rotated. Each of the chucking pins 346 may be linearly movable between a standby position and a support position along a radius direction of the main body 342. The standby position is a position further away from the center of the main body 342 than the support position. When the substrate W is loaded or unloaded on the spin chuck 340, the chucking pin 346 is disposed at the standby position. Also, when the process is performed on the substrate W, the chucking pin 346 is disposed at the support position. The chucking pin 346 contacts a side portion of the substrate W at the support position. Since the spin chuck 340 contacts various kinds of treating solutions for treating the substrate W, the spin chuck 340 may be formed of a material having superior chemical resistance. For example, the spin chuck 340 may be formed of a Teflon material.

The elevation unit 360 vertically and linearly moves the container 320. As the container 320 vertically moves, a relative height of the container 320 with respect to the spin chuck 340 may change. The elevation unit 360 includes a bracket 362, a moving shaft 364, and a driver 366. The bracket 362 is fixed to an outer wall of the container 320. The moving shaft 364 vertically moving by the driver 366 is fixedly coupled to the bracket 362. When the substrate W is placed on the spin chuck 340 or lifted from the spin chuck 340, the container 320 descends so that the spin chuck 340 protrudes upward from the container 320. Also, when the process is performed, the container 320 may be adjusted in height so that the treating solution is introduced into the preset recovery box 360 according to a kind of treating solution supplied onto the substrate W. For example, the substrate W is disposed at a height corresponding to the inner space 322a of the internal recovery box 322 while the substrate W is treated by using a first treating solution. Also, the substrates W may be respectively disposed at heights corresponding to the space 324a between the internal recovery box 322 and the intermediate recovery box 324 and the space 326a between the intermediate recovery box 324 and the external recovery box 326 while the substrates are respectively treated by using a second treating solution and a third treating solution. Alternatively, the elevation unit 360 may vertically move the spin chuck 340 in stead of the container 320.

The liquid supply member 380 supplies a treating solution onto the substrate W when the substrate cleaning process is performed. The liquid supply member 380 includes a nozzle support 382, a nozzle 384, a support shaft 386, and a driver 388. The support shaft 386 has a length direction parallel to the third direction 16. The driver 388 is coupled to a lower end of the support shaft 386. The driver 388 rotates and elevates the support shaft 386. The nozzle support 382 is vertically coupled to a side opposite to an end of the support shaft 386 coupled to the driver 388. The nozzle 384 is disposed on a bottom surface of an end of the nozzle support 382. The nozzle 384 moves at a process position and a standby position by the driver 388. The process position represents a position at which the nozzle 384 is disposed directly above the container 320, and the standby position represents a position at which the nozzle 384 is disposed deviational from the direct upper side of the container 320. The liquid supply member 380 may be provided in one or plurality. When the liquid supply member 380 is provided in plurality, a chemical, a rinsing solution, and an organic solvent may be provided through the liquid supply members 380 different from each other, respectively. The chemical may be an etching solution including hydrofluoric acid (HF), nitric acid, sulfuric acid, or ammonium. The rinsing solution may be pure water. The organic solvent may be a mixture of isopropyl alcohol and an inert gas or an isopropyl alcohol solution.

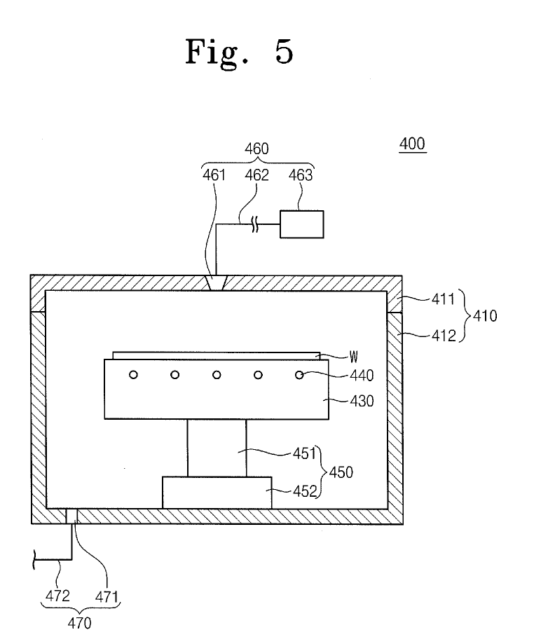

FIG. 5 is a cross-sectional view illustrating a second substrate cleaning apparatus of FIG. 3 according to an embodiment of the present invention.

A general substrate cleaning apparatus rotates a substrate W to vaporize a treating solution and pure water which remains on the substrate W. When the substrate W is rotated and then dried, an amount of evaporation may be different among patterns of the substrate W. Thus, an amount of treating solution and pure water remaining among the patterns may be different in a moment due to the difference of the amount of the evaporation. Here, surface tension in each of spaces among the patterns of the substrate W may be different. Thus, a leaning phenomenon of the patterns of the substrate W may occur.

According to an embodiment of the present invention, the substrate W may be uniformily heated and dried to maintain an amount of evaporation on the substrate W. When the amount of evaporation is uniformly maintained, the surface tension among the patterns may be constant. Thus, the leaning phenomenon of the patterns on the substrate W may be prevented to improve the substrate cleaning efficiency. Hereinafter, a substrate treating apparatus and method for uniformly heating and driving a substrate W will be described.

A second substrate cleaning apparatus 400 includes a drying housing 410, a substrate support member 430, a heater 440, a purge gas supply member 460, and an exhaust member 470. The second substrate cleaning apparatus 400 is disposed within the second process chamber 280. The second substrate cleaning apparatus 400 heats and dries a substrate W carried into the second process chamber 280.

The drying housing 410 provides a space in which the second substrate cleaning apparatus 400 dries the substrate W. The drying housing 410 includes an upper housing 411 and a lower housing 412. When the upper housing 411 ascends to open the drying housing 410, the substrate W is carried into the drying housing 410. When the substrate W moves into the drying housing 410, the upper housing 411 descends to close the drying housing 410. Alternatively, the lower housing 412 may descends to open the drying housing 410, and the lower housing 412 ascends to close the drying housing 410.

The substrate support member 430 is disposed within the drying housing 410 to support the substrate W carried into the drying housing 410. The substrate support member 430 may have a top surface contacting a bottom surface of the substrate W. Thus, the substrate support member 430 has a sectional area greater than that of the substrate W. The substrate support member 430 may be formed of a material having superior heat resistance to prevent the substrate support member 430 from being damaged when the substrate W is heated. For example, a top surface of the substrate support member 430 may be formed of a steel material having the superior heat resistance.

The substrate support member 430 includes a rotation member 450. The rotation member 450 includes a driving shaft 451 and a motor 452. The driving shaft 451 contacts a bottom surface of the substrate support member 430 to transfer rotation force generated in the motor 452 to the substrate support member 430. Although not shown, the substrate support member 430 may include a chucking pin (not shown). The chucking pin (not shown) fixes the rotating substrate W. Alternatively, the rotation member 450 may not be provided.

The heater 440 is disposed in the substrate support member 430 to heat the substrate W. For example, the heater 440 may include a heating wire having a coil shape and disposed within the substrate support member 430. When the heater 440 heats the substrate support member 430, the bottom surface of the substrate W contacting the substrate support member 430 is conduction-heated to dry the substrate W. Since the substrate W is heated by the heater 440 disposed with a uniform distance, an entire area of the substrate W may be uniformly heated. For another example, the substrate W may be heated while being rotated. Alternatively, a heater (not shown) may be provided as a lamp and disposed on an upper portion of the drying housing 410. In this case, the lamp may heat a top surface of the substrate W to dry the substrate W.

The purge gas supply member 460 supplies a purge gas into the drying housing 410. The purge gas supply member 460 includes an inflow port 461, a supply line 462, and a storage tank 463. The purge gas supply member 460 may be connected to a top surface of the drying housing 410. The purge gas stored in the storage tank 463 is introduced into the drying housing 410 through the supply line 462. An inert gas such as a nitrogen gas may be used as the purge gas. The purge gas may exhaust external gases introduced into the drying housing 410 when the drying housing 410 is opened, the evaporated treating solution, and fume from the inside of the drying housing 410.

The exhaust member 470 exhausts a fluid within the drying housing 410 to the outside. The exhaust member 470 includes an exhaust port 471 and an exhaust line 472. For example, the exhaust member 470 may be connected to the bottom surface of the drying housing 410.

Hereinafter, a substrate treating apparatus according to another embodiment will be described.

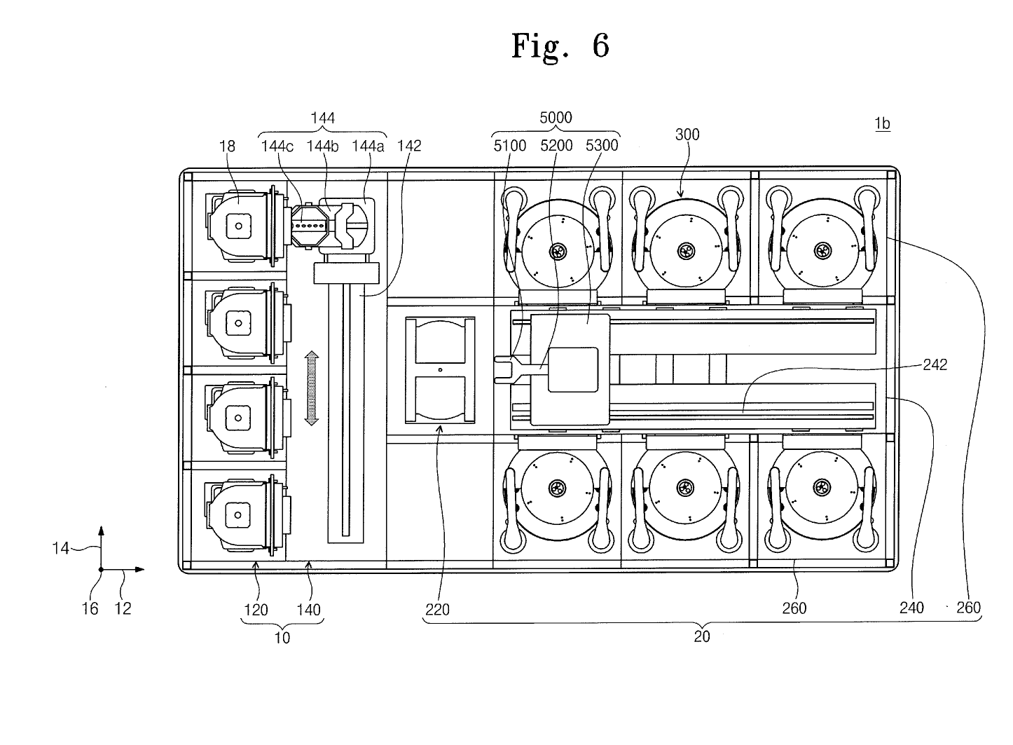

FIG. 6 is a plan view of a substrate treating apparatus according to another embodiment of the present invention.

Referring to FIG. 6, a substrate treating apparatus 1b includes an index module 10 and a process processing module 20. The index module 10 includes a load port 120 and a transfer frame 140. The loadport 120, the transfer frame 140, and the process processing module 20 are successively disposed in a line. The process processing module 20 includes a transfer chamber 240, a buffer unit 220, and a process chamber 260. A guide rail 242 and a carrying unit 5000 are disposed in the transfer chamber 240. Hereinafter, a direction in which the load port 120, the transfer frame 140, and the process processing module 20 are arranged is referred to as a first direction 12. Also, when viewed from an upper side, a direction perpendicular to the first direction 12 is referred to as a second direction 14, and a direction perpendicular to a plane parallel to the first and second directions 12 and 14 is referred to as a third direction 16.

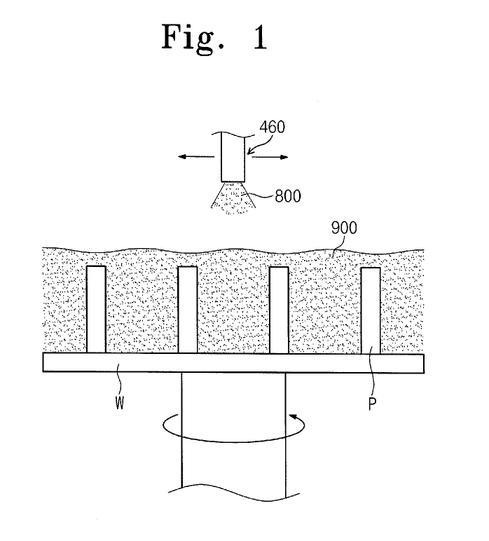

The substrate treating apparatus 1b includes a plurality of process chambers 260. Substrate cleaning apparatuses 300 within the process chambers 260 may be the same. Also, the transfer unit 5000 may have a shape different from that of the transfer unit 500 of FIG. 1. A substrate W may be heated and dried within the transfer unit 5000. In addition, the substrate treating apparatus 1b may have constitutes and functions equal or similar to those of the substrate treating apparatus 1a of FIG. 1. Hereinafter, different features between the substrate treating apparatus 1b according to another embodiment and the substrate treating apparatus 1a according to an embodiment will be mainly described.

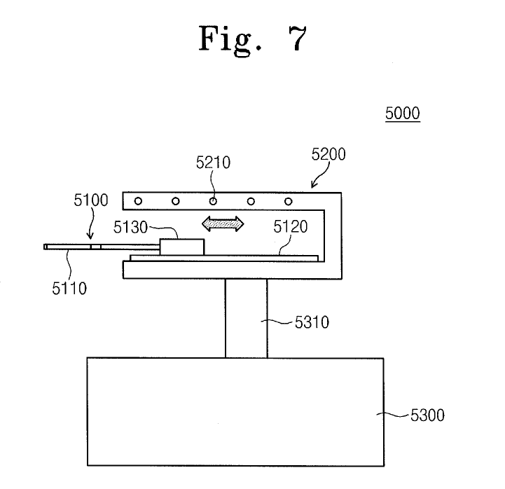

FIG. 7 is a cross-sectional view illustrating a substrate cleaning apparatus of FIG. 6 according to another embodiment of the present invention. According to current embodiment, a substrate W is heated and dried within the transfer unit 5000, but is not heated and dried within the process chamber 260.

Referring to FIGS. 6 to 7, the transfer unit 5000 includes a robot arm 5100, a housing 5200, and a base 5300.

The base 5300 is disposed on the guide rail 242 to linearly move in the first direction 12. A rotation shaft 5310 is disposed on a top surface of the base 5300. The rotation shaft 5310 may be connected to the housing 5200 so that the robot arm 5100 moves into the process chamber 260 while the housing 5200 rotates.

The housing 5200 may be disposed above the base 5300. Here, the housing 5200 may be spaced from the base 5300 by the rotation shaft 5310. The housing 520 provides a space in which the substrate W is heated and dried. The housing 5200 may have an opened surface on which the robot arm 5100 is disposed. Alternatively, the housing 5200 may have an openable surface on which the robot am 5100 is disposed. A heater 5210 may be disposed on a top surface of the housing 5200. The heater 5210 heats the substrate W moving into the housing 5200 together with the robot arm 5100. For example, the heater 5210 may be disposed above a moving path of the robot arm 5100 within the housing 5200. Here, the heater 5210 may be provided as a lamp. In this case, the heater 520 may be disposed on the top surface of the housing 5200 to heat the substrate W without contacting the substrate W. Alternatively, the heater 5210 may be disposed below the moving path of the robot arm 5100 within the housing 5200. Although not shown, the housing 5200 may be provided in plurality. Also, the plurality of housings 5200 may be stacked on each other.

The robot arm 5100 supports the carried substrate W. For example, the robot arm 5100 may include a support part 5110, a rail 5120, and a main body 5130. The support part 5110 supports the carried substrate W. Although not shown, the support part 5110 may include a fixing member (not shown) for fixing the carried substrate W. The rail 5120 is disposed on a bottom surface of the inside of the housing 5200. The main body 5130 is disposed on the rail 5120 to move into the housing 5200 along the rail 5120. The main body 5130 is connected to the support part 5110. The support part 5110 may move into or out of the housing 5200 while moving along the rail 5120. Thus, the robot arm 5100 may move the substrate W from the process chamber 260 to the outside or move the substrate W into the process chamber 260. Also, the robot arm 5100 may move the substrate W into the housing 5200. Although not shown, the support part 5110 of the robot arm 5100 may be extendable in length.

In the substrate treating apparatus 1b, since the substrate W is heated and dried in the transfer unit 5000, the heating and drying process is not performed within the process chamber 260. Alternatively, the heating and drying process may be performed within the process chamber 260 in addition to the heating and drying process within the transfer unit 5000.

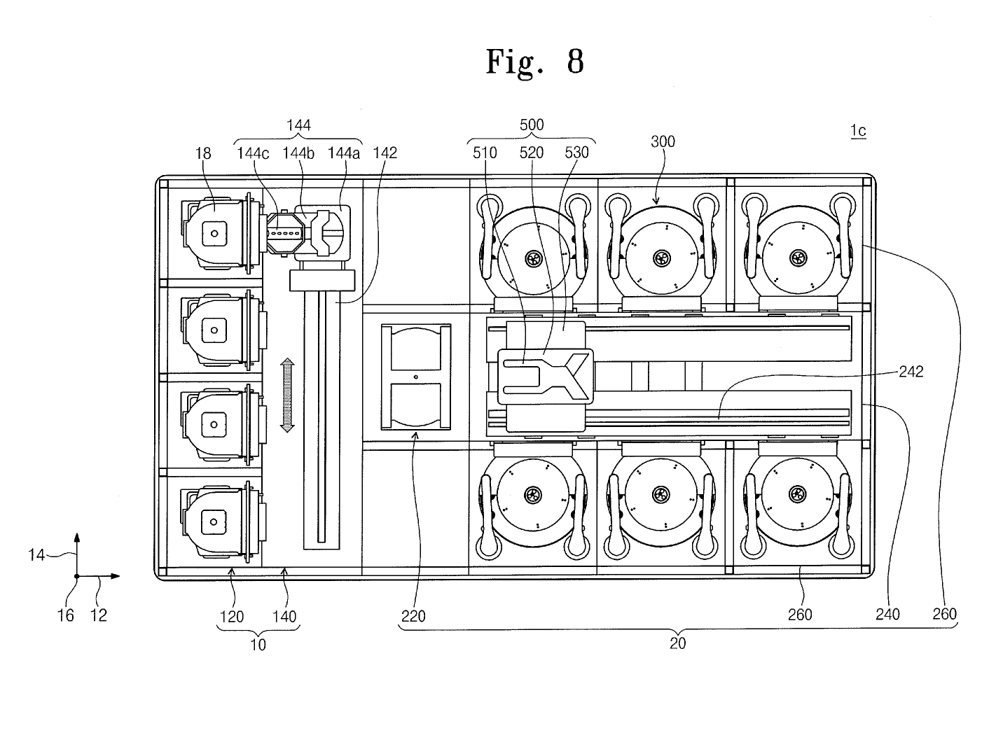

FIG. 8 is a plan view of a substrate treating apparatus according to further another embodiment of the present invention.

Referring to FIG. 8, a substrate treating apparatus 1c includes an index module 10 and a process processing module 20. The index module 10 includes a load port 120 and a transfer frame 140. The loadport 120, the transfer frame 140, and the process processing module 20 are successively disposed in a line. The process processing module 20 includes a transfer chamber 240, a buffer unit 220, and a process chamber 260. A guide rail 242 and a carrying unit 500 are disposed in the transfer chamber 240. Hereinafter, a direction in which the load port 120, the transfer frame 140, and the process processing module 20 are arranged is referred to as a first direction 12. Also, when viewed from an upper side, a direction perpendicular to the first direction 12 is referred to as a second direction 14, and a direction perpendicular to a plane parallel to the first and second directions 12 and 14 is referred to as a third direction 16.

The substrate treating apparatus 1c includes a plurality of process chambers 260. Substrate cleaning apparatuses 300 within the process chambers 260 may be the same. For example, a substrate W is heated and dried within the substrate cleaning apparatus 300 within each of the process chamber 260. In addition, the substrate treating apparatus 1c may have constitutes and functions equal or similar to those of the substrate treating apparatus 1a of FIG. 1. Hereinafter, different features between the substrate treating apparatus 1c according to further another embodiment and the substrate treating apparatus 1a according to an embodiment will be mainly described.

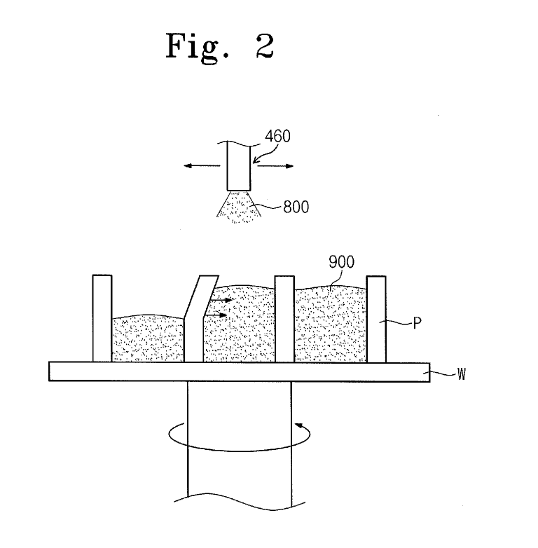

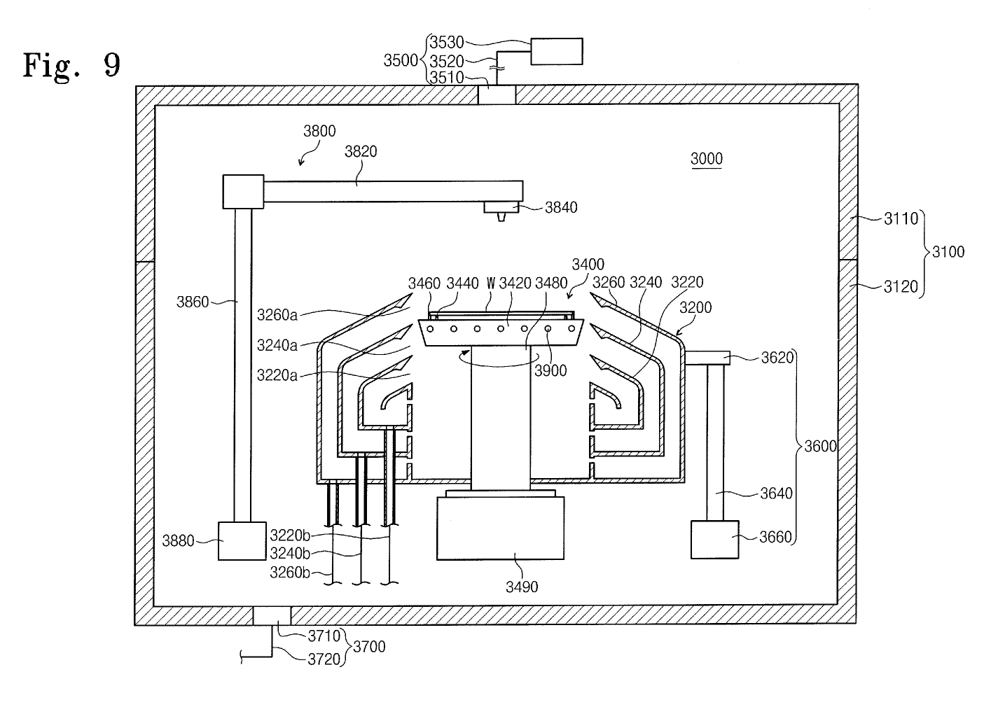

FIG. 9 is a cross-sectional view illustrating a substrate cleaning apparatus of FIG. 8 according to further another embodiment of the present invention. The substrate cleaning apparatus 300 of FIG. 9 has a structure in which a substrate W is heated and dried within the process chamber 260. In addition, the substrate cleaning apparatus 3000 may have constitutes and functions equal or similar to those of the substrate cleaning apparatus 300 of FIG. 2. Hereinafter, different features between the substrate cleaning apparatus 3000 according to further another embodiment and the substrate cleaning apparatus 300 of FIG. 2 will be mainly described.

Referring to FIGS. 8 and 9, the substrate cleaning apparatus 3000 includes a housing 3100, a container 3200, a spin chuck 3400, an elevation unit 3600, a liquid supply member 3800, a purge gas supply member 3500, and an exhaust member 3700. The housing 3100, the container 3200, the spin chuck 3400, the elevation unit 3600, and the liquid supply member 3800 of the substrate cleaning apparatus 3000 may have structures and functions similar to those of the first substrate cleaning apparatus 300 of FIG. 3.

The heater 3900 is disposed in the spin chuck 3400 to heat a substrate W. For example, the heater 3900 may have a coil shape and be disposed within the spin chuck 3400 with a uniform distance. When the heater 3900 heats the spin chuck 3400, a bottom surface of the substrate W contacting the spin chuck 3400 is conduction-heated to dry the substrate W. Alternatively, the substrate W may be heated while being rotated. Alternatively, a heater (not shown) may be provided as a lamp and disposed on an upper portion of the housing 3100. In this case, the lamp may heat a top surface of the substrate W to dry the substrate W.

The purge gas supply member 3500 supplies a purge gas into the housing 3100. The purge gas supply member 3500 includes an inflow port 3510, a supply line 3520, and a storage tank 3530. For example, the exhaust member 3500 may be disposed on an upper housing 3110. The purge gas may be an inert gas. For example, a nitrogen gas may be used as the purge gas.

The exhaust member 3700 exhausts a fluid within the housing 3100 to the outside. The exhaust member 3700 includes an exhaust port 3710 and an exhaust line 3720. For example, the exhaust member 3700 may be connected to a bottom surface of a lower housing 3120.

The embodiments of the above-described substrate treating apparatus may be combined with each other.

Hereinafter, a substrate treatment method using the substrate treatment apparatus 1000 according to the present invention will be described.

In descriptions of a substrate treating method, the substrate treating method using the substrate treating apparatus according to the present invention may be merely an example for easily explaining. Thus, the current embodiment is not limited by the substrate treating apparatus according to the present invention.

Thus, the substrate treating method according to the present invention may be performed using other substrate treating apparatuses capable of performing functions equal or similar to those of the substrate treating apparatus, except for the substrate treating apparatus according to the present invention.

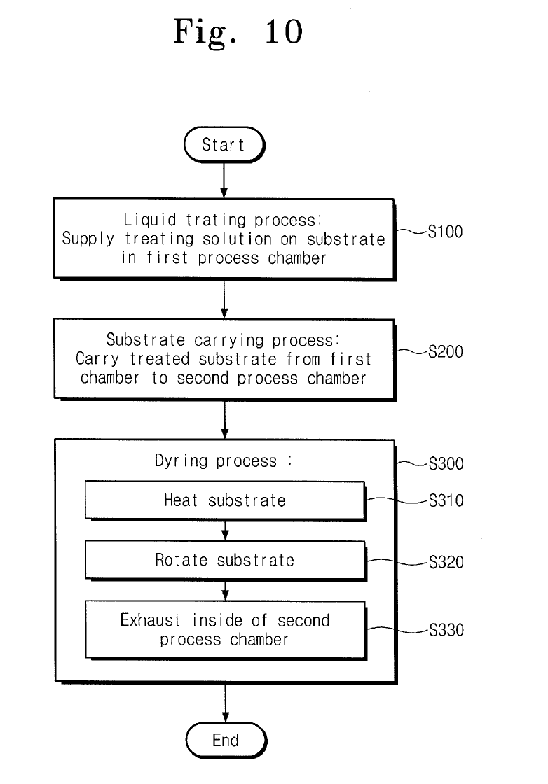

FIG. 10 is a flowchart illustrating a method for cleaning a substrate by using the substrate treating apparatus of FIG. 3.

Referring to FIG. 3, a substrate cleaning method includes a liquid treating process S100, a substrate transfer process S200, and a drying process 5300.

The liquid treating process S100 is performed by supplying a treating solution onto a substrate in a first process chamber. Isopropyl alcohol may be used as the supplied treating solution. In the substrate transfer process S200, the substrate treated by using the liquid solution in the first process chamber is carried into a second process chamber. The drying process S300 includes a process S310 of heating a substrate, a process S320 of rotating the substrate, and a process S330 of exhausting the inside of the second process chamber. Hereinafter, the process 5300 of drying the substrate will be described in detail.

According to an embodiment of the present invention, in the process S300 of drying the substrate, a substrate W is heated so that the substrate W is uniformly dried (S310). For example, a bottom surface of the substrate W may be heated by a heater. Alternatively, a top surface of the substrate W may be heated by a lamp disposed above the substrate W. For example, the process of heating of the substrate w may be performed within the second process chamber 280. For another example, the substrate W may be heated in the first process chamber or a transfer unit 500. When the substrate W is uniformly heated, a treating solution remaining on the substrate W may be uniformly dried. Since the treating solution remaining on the substrate W is uniformly dried, surface tension of the treating solution remaining on patterns of the substrate W may be uniformly maintained among the patterns. Thus, a leaning phenomenon of the substrate W may be prevented. Alternatively, the drying process S310 due to the heating may be performed just after the liquid treating process S100 without performing the drying process by supplying another fluid.

The process 5300 of drying the substrate W includes a process S320 of rotating the substrate W. For example, the process S320 of rotating the substrate W may be performed together with the process 5310 of heating the substrate W at the same time. Since the substrate W is rotated while the substrate W is heated, substrate cleaning efficiency may be improved. Alternatively, the process S320 of rotating the substrate W may be performed first than the process 5310 of heating the substrate W.

The process 5300 of drying the substrate W includes a process 5330 of exhausting the inside of the second process chamber. A purge gas may be supplied into the second process chamber 280, and then, the purge gas together with external gases, an evaporated treating solution, and fume may be exhausted to the outside of the second process chamber 280. For example, the exhaust process 5330 may start at the process 5200 of transferring the substrate W into the second process chamber. When the external gases are introduced into the second process chamber while the substrate W is carried into the second process chamber, the inside of the second process chamber may be exploded due to a high temperature during the drying process. Thus, to prevent this phenomenon, the exhaust process 5330 may start at the process 5200 of transferring the substrate W into the second process chamber. For example, a nitrogen gas as an inert gas may be used as the purge gas. On the other hand, if the substrate drying process 5300 is performed within the first process chamber, the inside of the first process chamber may be exhausted.

According to the present invention, the drying efficiency may be improved by the substrate cleaning apparatus and method.

According to the present invention, the substrate may be dried at a uniform rate to prevent the leaning phenomenon from occurring.

The feature of the present invention is not limited to the aforesaid, but other features not described herein will be clearly understood by those skilled in the art from this specification and the accompanying drawings.

The foregoing detailed descriptions may be merely an example of the prevent invention. Having now described exemplary embodiments, those skilled in the art will appreciate that modifications may be made to them without departing from the spirit of the concepts that are embodied in them. Further, it is not intended that the scope of this application be limited to these specific embodiments or to their specific features or benefits. Rather, it is intended that the scope of this application be limited solely to the claims which now follow and to their equivalents.

What is claimed is:

1. A substrate cleaning apparatus comprising:
a first process chamber in which a liquid treating process is performed on a substrate by supplying a treating solution;
a second process chamber in which a drying process is performed on the substrate; and
a carrying unit carrying the substrate between the first process chamber and the second process chamber,
wherein the first process chamber comprises:
a liquid treating housing providing a space in which the liquid treating process is performed on the substrate;
a spin chuck supporting the substrate within the liquid treating housing; and
a liquid supply member supplying the treating solution onto the substrate supported by the spin chuck,
wherein the second process chamber comprises:
a drying housing providing a space in which the substrate is dried;
a substrate support member supporting the substrate within the drying housing; and
a heater heating the substrate.

2. The substrate cleaning apparatus of claim 1, wherein the substrate support member has a top surface that is formed of a material having heat resistance greater than that of a top surface of the spin chuck.

3. The substrate cleaning apparatus of claim 2, wherein the spin chuck has the top surface that is formed of a material having chemical resistance greater than that of the top surface of the substrate support member.

4. The substrate cleaning apparatus of claim 3, wherein the top surface of the substrate support member is formed of a steel material, and
the top surface of the spin chuck is formed of a Teflon material.

5. The substrate cleaning apparatus of claim 1, wherein the heater is disposed in the substrate support member.

6. The substrate cleaning apparatus of claim 1, wherein the second process chamber further comprises:
a purge gas supply member supplying a purge gas into the drying housing; and
an exhaust member the purge gas and fume to the outside of the drying housing.

7. The substrate cleaning apparatus of claim 6, wherein the purge gas comprises an inert gas.

8. The substrate cleaning apparatus of claim 1, wherein the substrate support member comprises:
a support plate disposed on the substrate support member to face the substrate, the support plate being rotated together with the substrate; and
a rotation member rotating the support plate.

9. A substrate cleaning apparatus comprising:
a first process chamber in which a liquid treating process is performed on a substrate by supplying a treating solution;
a carrying unit carrying the substrate from the first process chamber; and
a drying member drying the carried substrate,
wherein the drying member is disposed in the carrying unit.

10. The substrate cleaning apparatus of claim 9, wherein the carrying unit comprises:
a base;
a housing disposed on the base to provide a space in which the substrate is dried; and
a robot arm supporting the substrate, the robot arm being movable between a first position at which the substrate moves into a cleaning chamber and a second position at which the substrate within the housing is dried.

11. The substrate cleaning apparatus of claim 10, wherein the drying member is disposed within the housing.

12. The substrate cleaning apparatus of claim 11, wherein the drying member is disposed above a moving path of the robot arm within the housing.

13. The substrate cleaning apparatus of claim 11, wherein the housing further comprises:
a purge gas supply member supplying a purge gas into the housing; and
an exhaust member the purge gas and fume to the outside of the housing.

14. A substrate cleaning method comprising:
performing a liquid treating process on a substrate; and
drying the substrate,
wherein, in the drying of the substrate, the substrate is dried by heating.

15. The method of claim 14, wherein the liquid treating process is performed in a first process chamber, and
the drying process is performed in a second process chamber.

16. The method of claim 15, wherein the drying process is performed after the liquid treating process is performed without supplying another treating solution.

17. The method of claim 16, wherein the liquid treating process comprises:
supplying pure water onto the substrate; and
supplying a liquid organic solvent onto the substrate.

18. The method of claim 15, further comprising introducing a purge gas into the second process chamber to exhaust the purge gas together a gas introduced into the outside of the second process chamber, evaporated pure water, or an organic solvent to the outside of the second process chamber.

19. The method of claim 16, wherein the purge gas comprises an inert gas.

20. The method of claim 18, wherein the exhaust process starts at a time point at which the substrate is carried into the second process chamber.

21. The method of claim 15, wherein the drying process comprises rotating the substrate,
wherein the substrate is rotated while being heated and is dried.

22. The method of claim 14, further comprising carrying the substrate between the chambers,
wherein the liquid treating process is performed in a first process chamber, and
the drying process is performed in a carrying unit by which the substrate is carried from the first process chamber after the liquid treating process is performed.

23. The method of claim 14, wherein the drying process is performed in a first process chamber in which the liquid treating process is performed on the substrate.
